(19) United States
(12) Patent Application Publication
(10) Pub. No.: US 2016/0183476 A1
(43) Pub. Date: Jun. 30, 2016

(54) Mobile Plant Service System and Components Therefor

(71) Applicant: MICROWARE LIMITED, Gibraltar (GI)

(72) Inventor: Bentsion KABAKOV, QUEENSWAY QUAY (GI)

(21) Appl. No.: 14/582,259

(22) Filed: Dec. 24, 2014

(51) Int. Cl. A01G 7/06; A01M 5/02; A01M 7/00

(52) U.S. Cl. CPC A01G 7/06; A01M 7/005; A01M 5/02

(57) ABSTRACT

A mobile plant service system for treating plants in a crop growing area includes a transport device deployed for moving across the crop growing area. A spraying apparatus mounted to the transport device for delivering an atomized liquid to the plants in the crop growing area includes a plurality of spray nozzles, a pressure vessel for storing compressed air, a pressure regulating valve assembly, and a receptacle containing a liquid. A flow controller actuates the pressure regulating valve assembly to allow the flow of a controlled release of compressed air to the plurality of spray nozzles at a spray out pressure.

### FIELD AND BACKGROUND OF THE INVENTION

The present invention relates to plant service systems.

It is known that the delivery of a liquid spray to plants is possible by the use of spray device. Such sprays are typically created by combining compressed air and a liquid in order to generate an atomized spray. The generation of a fine spray, as is useful for non-toxic pesticide sprays, requires the release of compressed air at pressure levels which are typically higher than for coarse sprays. However, such spray devices are limited in mobility as they require a fixed connection to a remote air compressor. Alternatively, a high voltage power supply in connection with an air compressor may be locally connected to a spray device. However, the use of high voltage equipment in a wet environment, such as a greenhouse, increases the risk of electric shock, equipment damage, and other safety hazards.

### SUMMARY OF THE INVENTION

The present invention is a system and corresponding components for providing a mobile plant service functionality.

According to the teachings of an embodiment of the present invention there is provided, a mobile plant service system for treating plants in a crop growing area comprising: (a) a transport device deployed for moving across the crop growing area; (b) a spraying apparatus mounted to the transport device for delivering an atomized liquid to the plants in the crop growing area, comprising: (i) a plurality of spray nozzles; (ii) a pressure vessel in fluid flow connection with the plurality of spray nozzles configured for storing compressed air at a storage pressure; (iii) a pressure regulating valve assembly in fluid flow connection with the pressure vessel; (iv) a receptacle containing a liquid in fluid flow connection with the spray nozzles; (c) a flow controller associated with the pressure regulating valve assembly; and (d) a rechargeable power supply deployed to provide power to the flow controller, wherein the flow controller is configured to actuate the pressure regulating valve assembly to allow the flow of a controlled release of compressed air to the plurality of spray nozzles at a spray out pressure.

According to a further feature of an embodiment of the present invention, the transport device is a gantry.

According to a further feature of an embodiment of the present invention, the mobile plant service system for treating plants in a crop growing area further comprises a plurality of fans mounted to the gantry; wherein each of the fans has variable rotary speeds and directions of rotation, and wherein each of the fans is associated with a fan controller, and wherein the fan controller is configured to selectively actuate each of the fans to independently operate in a plurality of operational modes, and wherein each of the operational modes corresponds to at least one rotary speed and direction of rotation.

According to a further feature of an embodiment of the present invention, each of the fans has variable blade angles, and wherein each of the operational modes corresponds to at least one rotary speed, direction of rotation, and blade angle.

According to a further feature of an embodiment of the present invention, the mobile plant service system for treating plants in a crop growing area further comprises an actuator associated with the fan controller; wherein the actuator is configured to adjust a pointing angle of each of the fans.

According to a further feature of an embodiment of the present invention, the actuator is further configured to adjust a blade angle of each of the fans.

According to a further feature of an embodiment of the present invention, the flow controller and the fan controller are implemented as a single processing system having at least one processor.

According to a further feature of an embodiment of the present invention, the operation modes include: (i) a pest reduction mode, wherein any or all of the fans operate to create a suction air flow whereby pests in proximity of a fan are sucked into the blades of the fan; (ii) a plant stressing mode, wherein any or all of the fans operate at angles and speeds designed to stress a specified plant; and (iii) a pollination mode, wherein any or all of the fans operate at angles and speeds designed for artificial pollination of specified plants.

According to a further feature of an embodiment of the present invention, the mobile plant service system for treating plants in a crop growing area further comprises a plurality of nets with a sieve opening size of at most 0.5 millimeters, wherein the nets are attached to the fans; and wherein the nets are configured to retain pests sucked into the fans when operating in the pest protection mode.

According to a further feature of an embodiment of the present invention, the mobile plant service system for treating plants in a crop growing area further comprises a plurality of wheel assemblies mounted to the gantry, wherein each of the wheel assemblies comprises: (i) at least one wheel; (ii) a braking arrangement associated with the at least one wheel; (iii) a drive system associated with the at least one wheel; and (iv) a wheel controller associated with the braking arrangement and the drive system, wherein the at least one wheel is configured to operate along a profile disposed about the periphery of the crop growing area, and wherein the rechargeable power supply is deployed to provide power to the drive system, and wherein the wheel controller is configured to actuate the drive system to rotate the at least one wheel at an adjustable direction of rotation and to selectively operate the braking arrangement.

According to a further feature of an embodiment of the present invention, the mobile plant service system for treating plants in a crop growing area further comprises a home station with a stationary charging arrangement; wherein the gantry has a home position in the home station, and wherein the stationary charging arrangement is configured to come into operative cooperation with the rechargeable power supply when the gantry is in the home position.

According to a further feature of an embodiment of the present invention, the home station further comprises a compressed air filling linkage associated with a mains voltage power supply; wherein the compressed air filling linkage is deployed for connection with the pressure vessel when the gantry is in the home position, and wherein the mains voltage power supply is an alternating current (AC) power supply configured to supply a voltage of at least 100 volts AC.

According to a further feature of an embodiment of the present invention, the mobile plant service system for treating plants in a crop growing area further comprises a platform mounted to the gantry, wherein the platform extends along a majority of the gantry.

According to a further feature of an embodiment of the present invention, the mobile plant service system for treating plants in a crop growing area further comprises a lifter mounted to the gantry; wherein the lifter is configured to lift growing troughs containing plants grown by hydroponics and/or aeroponics.

According to a further feature of an embodiment of the present invention, the mobile plant service system for treating plants in a crop growing area further comprises at least one RFID reader mounted to the gantry and operable to transmit an interrogator signal and to receive an authentication signal, such that, wherein the at least one RFID reader passes over an RFID tag in a growing trough and transmits interrogator signals, authentication signals are generated, thereby indicating a position of the growing trough and a treatment type for the plants in the crop growing area.

According to a further feature of an embodiment of the present invention, the storage pressure is in a range from 5 atm to 12 atm.

According to a further feature of an embodiment of the present invention, the spray output pressure is in a range from 3 atm to 4 atm.

According to a further feature of an embodiment of the present invention, the receptacle is a reservoir containing a liquid; and wherein the reservoir is in fluid flow connection with the pressure vessel, and wherein the pressure vessel is further configured to pressurize the liquid in the reservoir.

According to a further feature of an embodiment of the present invention, the rechargeable power supply is a direct current (DC) power supply configured to supply a voltage of no more than 25 volts DC.

According to a further feature of an embodiment of the present invention, the mobile plant service system for treating plants in a crop growing area further comprises a pump associated with the rechargeable power supply and in fluid flow connection with the pressure vessel, wherein the flow controller is further configured to actuate the pump to pressurize the pressure vessel.

According to a further feature of an embodiment of the present invention, the spraying apparatus is configured to generate spray with a liquid droplet size in a range from 8-50 microns.

### BRIEF DESCRIPTION OF THE DRAWINGS

The invention is herein described, by way of example only, with reference to the accompanying drawings, wherein:

FIG. 1 illustrates a schematic diagram of spraying system mounted to a transport device according to an embodiment of the invention;

FIG. 2 illustrates a schematic diagram of a pressure regulating valve assembly according to an embodiment of the invention;

FIG. 3 illustrates a schematic diagram of a motorized gantry according to an embodiment of the invention;

FIG. 4 illustrates a schematic diagram of a motorized gantry in a home position according to an embodiment of the invention; and

FIG. 5 illustrates a schematic diagram of pressure vessels as a structural component of a gantry.

### DESCRIPTION OF THE PREFERRED EMBODIMENTS

The present invention is a system and corresponding components for providing a mobile plant service functionality.

The principles and operation of a system and corresponding components according to the present invention may be better understood with reference to the drawings and the accompanying description.

The present invention is applicable to various techniques of crop growing, and is of particular value when applied to mechanized production-line-type growing areas in which plants are cultivated in containers, such as growing troughs or the like, which advance from a planting location to a harvesting location. The potential applications of the present invention should not be limited to the applications used for the purposes of illustrating the principles and operation of a system and corresponding components according to the present invention.

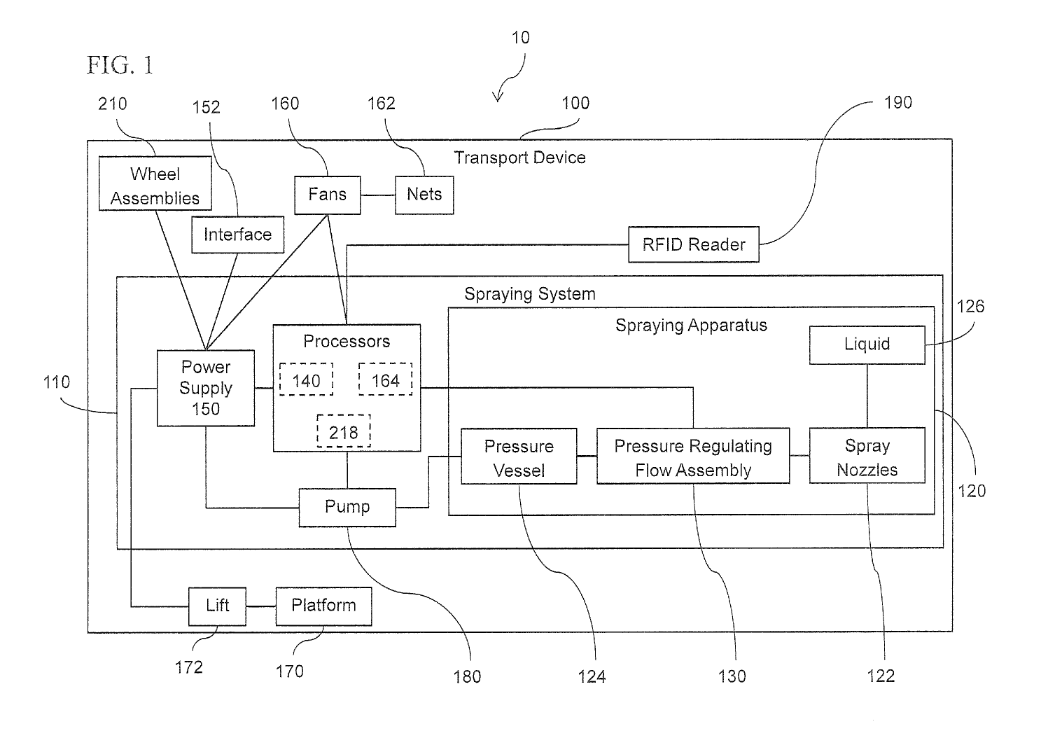

Referring now to the drawings, FIG. 1 is an overall schematic diagram of a system 10 and corresponding components for providing a mobile plant service functionality. With reference to FIG. 1, major elements of system 10 preferably include a transport device 100 for moving across a crop growing area and a spraying system 110 preferably mounted to the transport device 100. Spraying system 110 preferably includes a spraying apparatus 120 for delivering an atomized liquid to plants in the crop growing area, a flow controller 140 for regulating the flow of liquid from the spraying apparatus 120, and a rechargeable power supply 150 deployed to supply power to flow controller 140. For the purpose of this document, power supplies of at least 100 volts AC or DC are defined as “mains voltage power supply” or “high voltage”, whereas power supplies and devices operating on voltages of no more than 25 volts are termed “low voltage”. In more specific terms, a mains voltage power supply in the United States typically supplies power in the range of 100-120 volts AC, while a mains voltage power supply in Europe typically supplies power in the range of 220-240 volts AC. It is preferred that the rechargeable power supply is a rechargeable battery of low voltage in order to mitigate the possibility of electric shock or other hazards from operating in a high-moisture environment. Rechargeable power supply 150 is preferably a rechargeable battery with a maximum voltage of 24 volts DC, and typically 12 volts DC. Most preferably, rechargeable power supply 150 is a lead-acid car battery of 12 volts DC. Spraying apparatus 120 preferably includes a plurality of spray nozzles 122, a pressure vessel 124 in fluid flow connection with the spray nozzles 122, a pressure regulating valve assembly 130 in fluid flow connection with pressure vessel 124, and a receptacle 126 in fluid flow connection with spray nozzles 122 for containing a liquid that is to be atomized. Types of atomized liquid may include, but are not limited to, nutrient rich solutions and pesticide solutions. Preferably, the pesticide solutions are natural pesticides which are non-toxic to humans. Examples of non-toxic pesticide solutions include, but are not limited to, copper sulphate potassium hydrogen carbonate solutions, pyrethrum solutions, azadirachtin solutions, and solutions based on neem oil. Such non-toxic pesticide solutions may be less potent than toxic pesticides. Non-toxic pesticides may therefore need greater coverage and penetration of the plants in the crop growing area in order to achieve an equivalent effect to alternative techniques using toxic pesticides. It is therefore advantageous to generate an atomized mist to facilitate the coverage and penetration of the plants in the crop growing area by non-toxic pesticides. Pressure vessel 124 acts as an accumulator storing pressure for use over a period of time. Preferably, pressure vessel 124 is a tank of compressed air, hereinafter referred to as a tank, configured to store compressed air at a storage pressure. Preferably, tank 124 may be re-pressurized by a pressure source.

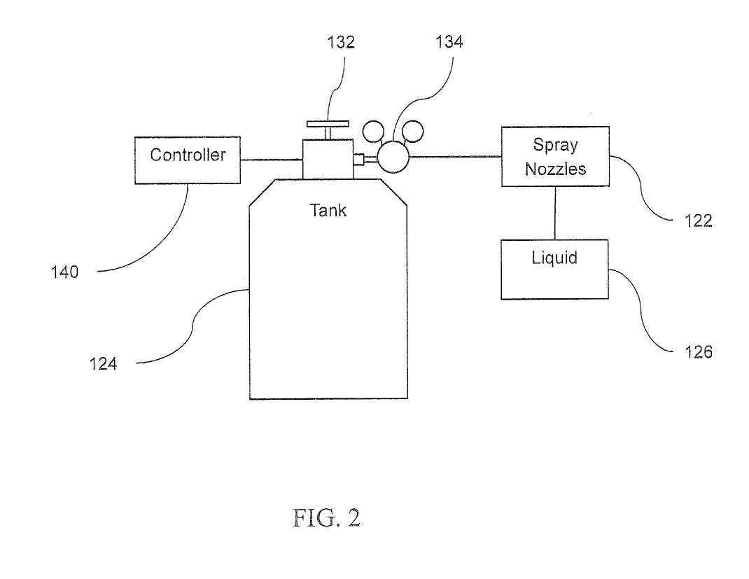

Preferably, pressure regulating valve assembly 130 is configured to control the air flow to spray nozzles 122 from tank 124 when actuated by flow controller 140. Preferably, the air pressure of the compressed air that is delivered to the spray nozzles is selectively reduced by pressure regulating valve assembly 130 when actuated by flow controller 140. With reference to FIG. 2, major elements of pressure regulating valve assembly 130 preferably include a valve 132 configured to operate in an open position and in a closed position, and a pressure regulator 134 configured to regulate the output air pressure of tank 124. It is preferred that when valve 132 is in the closed position, air is prevented from flowing out of tank 124. Furthermore, it is preferred that when valve 132 is in the open position, there is an impedance of low air flow from tank 124. Preferably, pressure regulator 134 is configured to selectively regulate the output air pressure of tank 124 by reducing the air pressure to a spray out pressure when the compressed air is delivered to spray nozzles 122. The functions of opening valve 132, closing valve 132, and regulating the output air pressure of tank 124 are performed when actuated by flow controller 140. Preferably, the maximum storage pressure in tank 124 is in the range of 5-12 atmospheres (atm). Preferably, the spray out pressure of the compressed air delivered to spray nozzles 122 from tank 124 is in the range of 2-5 atmospheres (atm), and is typically in the range of 3-4 atmospheres (atm). It is preferable that when the spray out pressure falls below the minimum pressure of the preferred spray out pressure range, tank 124 is re-pressurized in order to facilitate the spraying process. The liquid in receptacle 126 is preferably delivered to spray nozzles 122 by a suitable technique, including, but not limited to, Venturi suction, pressurization of the liquid, and pumping the liquid via pumping system or the like. Preferably, the liquid and the compressed air are combined in an atomizer spray head to generate an atomized mist for delivering to the plants in the crop growing area. The spray out pressure range facilitates that the atomized liquid be delivered at variable flow rates. Preferably, the spray out pressure range also allows for the atomized liquid to contain liquid droplets in the range of 8-150 microns, and is typically in the range of 8-50 microns. The small liquid droplet size of the mist results in a larger surface contact area of the liquid with the plants in the crop growing area. Although the system described thus far has pertained to a liquid being moved from a receptacle 126 to spraying nozzles 122 via a pump or the like, other embodiments are possible in which the liquid to be atomized is stored in a reservoir that is in fluid flow connection with tank 124. In such an embodiment, tank 124 may be configured to pressurize the liquid in the reservoir prior to the delivery of the liquid to spray nozzles 122. Spraying system 110 is preferably mounted to transport device 100 in order to maximize the range and precision of the atomized spray. Types of transport devices 100 include, but are not limited to, gantries, carts, and ceiling mounted trolleys.

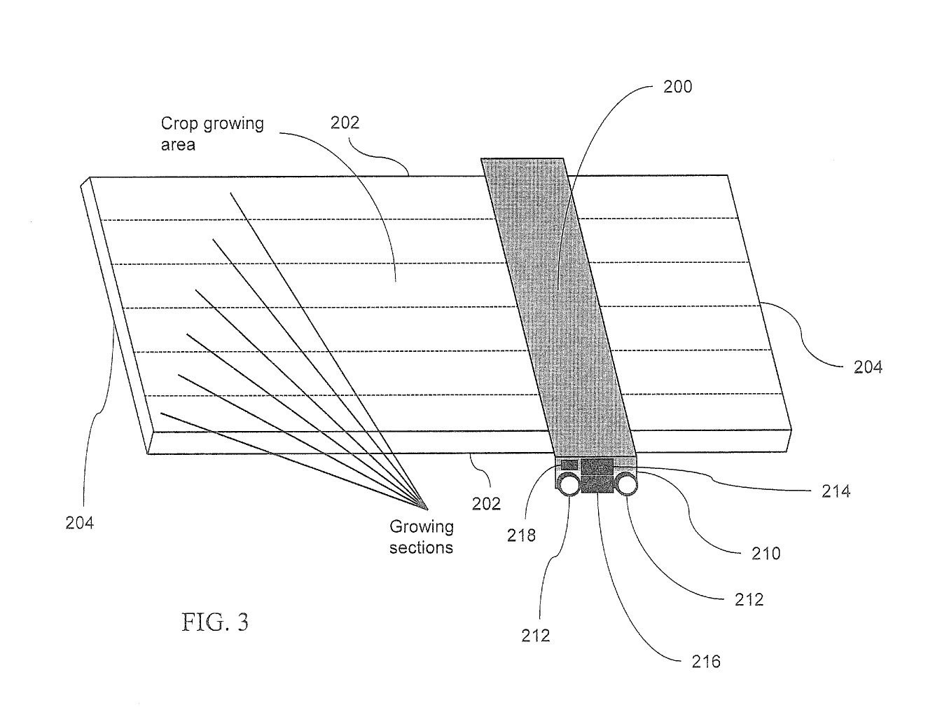

According to certain preferred embodiments, the transport device is a gantry 200 which extends across the entire width of a crop growing area as depicted in FIG. 3. The crop growing area may be defined by lateral borders 202 and ends 204 and may be subdivided into multiple growing sections. The length of gantry 200 is sufficient to provide spray coverage over the entire area under the gantry, not including any mechanical support elements which extend outside of the crop growing area. Preferably, gantry 200 is made moveable by a plurality of wheel assemblies 210 attached to mechanical support elements of gantry 200. Major elements of a wheel assembly 210 preferably include at least one wheel 212, a drive system 214 for rotating the at least one wheel 212 at an adjustable direction of rotation, a braking arrangement 216, and a wheel controller 218 for selectively actuating drive system 214 and braking arrangement 216. It is preferable that rechargeable power supply 150 is deployed to supply power to the drive system 214 of each wheel assembly 210 and to the wheel controller 218 associated with the wheel assemblies 210. Each drive system 214 preferably includes a DC motor for providing speed control and rotational direction control. Gantry 200 may stop moving when the power to the motor of each drive system 214 is interrupted. In this case, the stopping of gantry 200 is due to the removal of an externally supplied rotational force coupled with the natural force of friction between the at least one wheel 212 and the surface along which the at least one wheel 212 operates. While friction may be the primary impetus for stopping the motion of gantry 200, minor variations in the position of gantry 200 may occur while performing various procedures, including, but not limited to, the spraying of plants under gantry 200. Braking arrangement 216 may be configured to provide stability to gantry 200 when the gantry is stopped. The functionality of braking arrangement 216 should not be limited to providing stability. Braking arrangement 216 may be further configured to contribute to the stopping of gantry 200 while power is being provided to the motor of drive system 214. Types of braking arrangements 216 may include, but are not limited to, drum brakes, disk brakes, and hydraulic brakes. However, in many cases, a simple braking arrangement 216 is used where a brake pad is configured to press down on the at least one wheel 212 when actuated by wheel controller 218. Flow controller 140 and wheel controller 218 may be implemented using a single processing system with one or more processor in order to provide control functionality by a single device for regulating the flow of liquid from spraying apparatus 120 and for controlling the braking arrangement 216 and the drive system 214 of each wheel assembly 210. It is preferred that the elements of all the wheel assemblies 210 be synchronized such that the direction of rotation and speed of rotation of all wheels 212 mounted to the gantry 200 is uniform. The wheel assemblies 210 are preferably configured to operate along the perimeter of the crop growing area. Preferably, a solid frame structure is disposed along lateral borders 202 of the crop growing area. Types of materials used for constructing the frame may include, but are not limited to, steel, aluminum, and other suitable materials capable of supporting weights an order of magnitude greater than the weight of gantry 200. Preferably, the drive system 214 of each wheel assembly 210 is configured to drive one wheel of the wheel assembly 210. Preferably, the wheels 212 of each wheel assembly 210 are configured to operate along a suitably shaped profile such as a track or the like. Preferably, the upper portion of the frame structure is constructed to serve as a suitably shaped profile. Other embodiments are possible in which a rail track system is attached to the frame structure by hardware fasteners or the like. The rail track system may also be welded to the frame structure. In such an embodiment, the wheels 212 of each wheel assembly 210 are configured to operate along the rail track portion of the frame structure. Since the wheels 212 of each wheel assembly 210 are configured to operate along the upper portion of the frame structure, the portion of the greenhouse dedicated to the crop growing area is increased thereby maximizing the usable proportion of the available area. The controlled delivery of the atomized spray may be aided by devices which focus the delivery of the spray in a specified direction, including, but not limited to, fans, blowers, and air vents.

According to certain preferred embodiments, a plurality of fans 160 is mounted to gantry 200. Preferably each fan 160 is supplied power by rechargeable power supply 150. Preferably, each fan 160 is equipped with at least one motorized impeller with at least three impeller blades, more preferably at least five, and most preferably at least seven blades. The use of a relatively large number of blades has been found to improve the efficiency of the fan in functioning as a mechanical pest control device, effectively breaking up the bodies of insects that are drawn by airflow into the fans. Preferably, each motorized impeller is operable at various speeds as well as being operable in a clockwise direction of rotation and a counter clockwise direction of rotation to selectively provide blowing and suction. Preferably, the pitch angle of the impeller blades is adjustable, most preferably while the motorized impeller is rotating. An example of a fan with adjustable impeller blade pitch angle during impeller rotation is the “Variable Pitch Axial Fan” of Twin City Fan Companies Ltd. Clarage division. Varying the blowing and suction air flow generated by a fan can be achieved by adjusting the impeller rotational speed and the pitch angle of the impeller blades in any combination. The variable pitch angle of the impeller blades provides greater control of the airflow as well as a reduction in the power consumed by the fans. Preferably, each fan 160 has a dedicated fan controller 164 supplied power by rechargeable power supply 150 for providing control functionality to the motorized impellers of individual fans 160. Flow controller 140 and the fan controller(s) 164 may be implemented using a single processing system having one or more processor in order to provide control functionality by a single device for regulating the flow of liquid from spraying apparatus 120 and for providing coordinated control functionality to all fans. It is preferred that each fan 160 is mounted to gantry 200 via an adjustable mounting device in order to facilitate variable fan pointing angles. Types of adjustable mounting devices include, but are not limited to, pivot mountings and mountings with ball and socket joints. Preferably an actuator is associated with fan controller 164 and the adjustable mounting of each fan 160 in order to selectively control the pointing angle of individual fans 160. The impeller blade pitch angle of each fan may be adjusted manually or via an actuator associated with fan controller 164 and the impeller blades. The fans may be used for multiple purposes, including, but not limited to, distributing the atomized liquid to the plants, promoting pollination, stressing the plants to increase sustainability, and pest reduction. It is preferred that each fan 160 is equipped with at least one trap 162 configured to retain live insects which may get sucked through a fan by a fan's motorized impellers. Preferably, trap 162 is a netting of fine mesh with a sieve opening size in the range of 0.1-0.5 mm. It is preferred that the netting has a sock-like structure, with the open end of the netting attached to fan 160. The netting is preferably configured to inflate when provided air driven by fan 160. The netting preferably includes a structure to prevent the contents of the netting from escaping when the fan 160 is stopped or the airflow of fan 160 is reversed. The structure may be any suitable structure, including, but not limited to, flaps or the like configured to close over the open end and the folding of the netting when the netting is not inflated. Preferably, fan 160 includes a grill or the like for preventing the netting from being drawn into the blades of fan 160 when the airflow is reversed.

According to certain preferred embodiments, fans 160 are configured to operate in several modes of operation, including, but not limited to, a pest reduction mode, a plant stressing mode, and a pollination mode. Each mode of operation is preferably characterized by operating parameters which may include, but are not limited to, at least one speed of rotation, a motorized impeller direction of rotation, an impeller blade pitch angle, and at least one fan pointing angle. Preferably, a pest reduction mode includes the steps of operating any or all of fans 160 at a speed and direction which generates a sufficient suction air flow whereby pests, such as insects or the like, in proximity of a fan are sucked into the blades of the fan. Pests which are sucked past the blades of the fan, and emerge alive or wholly intact, are trapped in net 162 of the fan. A preferred range of the speed of rotation for pest reduction is 2000-3200 rotations per minute (rpm). The range of speed as well as the adjustable impeller blade angle facilitates the reduction of pests of size in the range of 0.1-10 millimeters. Preferably, a pollination mode includes the steps of operating any or all of fans 160 at a rotational speed of up to 1000 rotations per minute (rpm), either in a reverse fan direction or with inversion of the blade pitch in order to create sufficient air flow towards the plants to transfer pollen. Preferably, a plant stressing mode includes the steps of operating any or all of fans 160 at a rotational speed of up to 3200 rotations per minute (rpm) in order to generate a more powerful airflow towards the plants, thereby increasing the sustainability and viability of the plants. While the adjustable fan settings seek to reduce the power consumed by fans 160, the use of rechargeable power supply 150 supply power to the devices mounted to gantry 200 necessitates the capability to recharge power supply 150 quickly and efficiently.

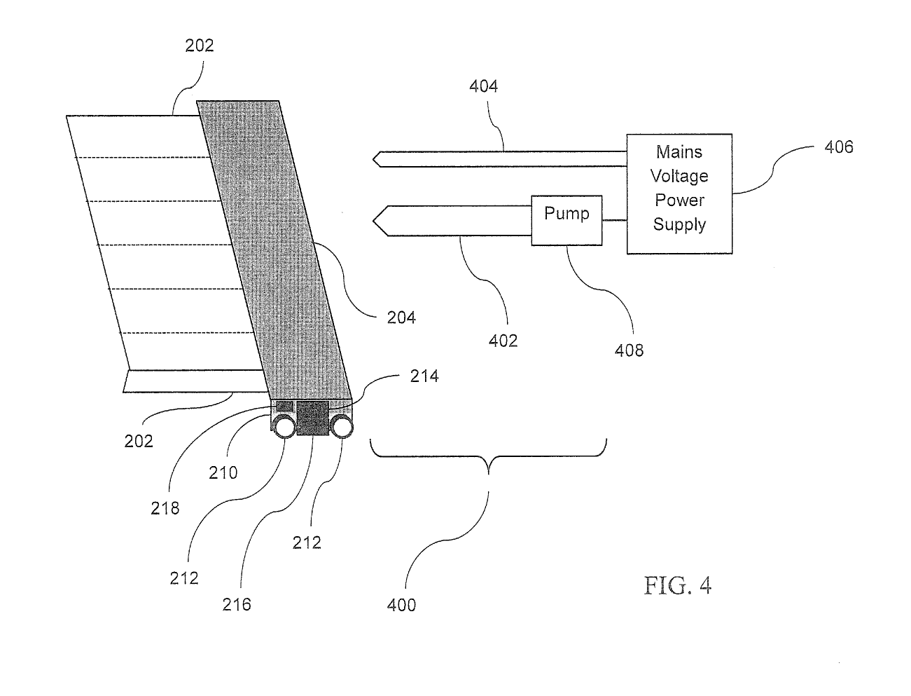

According to certain preferred embodiments, gantry 200 has one or more “home” positions where rechargeable power supply 150 can be recharged and tank 124 can be re-pressurized. With reference to FIG. 4, a “home” position is preferably defined by a home station 400 at or near an end 204 of the crop growing area. Home station 400 preferably includes a compressed air filling linkage 402 such as a hose with a releasable connector or the like for re-pressurizing tank 124 as well as a charging arrangement 404 for recharging rechargeable power supply 150. Compressed air filling linkage 402 is preferably in connection with a pump 408, which is preferably mounted outside the high-moisture growing area, and is powered by a mains voltage power supply 406. Preferably, compressed air filling linkage 402 is manually connected to tank 124. Preferably, charging arrangement 404 is configured to come into operative cooperation with rechargeable power supply 150 via a charging interface 152. Types of charging arrangements may include, but are not limited to, electrical contacts, inductive chargers, and other suitable connections. In an exemplary embodiment, the operative cooperation between rechargeable power supply 150 and charging arrangement 404 is configured to become connected to the power supply whenever gantry 200 returns to its home station without requiring human intervention, thus resulting in the automatic recharging of rechargeable power supply 150 when gantry 200 is in home position 400. Preferably, charging arrangement 404 includes a voltage converter. The voltage converter converts the electricity supplied by mains voltage 406 from AC electricity to DC electricity in order to supply rechargeable power supply 150. Although the system as described thus far has pertained to a spraying system 110 mounted to a gantry 200 with a home position 400 for re-pressurizing the tank 124 via compressed air filling linkage 402 in connection with a pump 408 powered by a mains voltage power supply 406, other embodiments are possible in which tank 124 is re-pressurized while the gantry 200 is not in a home position 400. Furthermore, even where the principal source of air pressure for tank 124 is from pump 408, it may be advantageous to provide the capability of topping up the air pressure while gantry 200 is away from its home position 400. In such cases, a pressurization pump 180 mounted to gantry 200 is supplied power by rechargeable power supply 150. Pressurization pump 180 re-pressurizes tank 124 when actuated by a control device associated with rechargeable power supply 150, preferably flow controller 140. Such an embodiment is particularly useful when rechargeable power supply 150 has enough charge to supply power to the necessary components of system 10, but the compressed air in tank 124 falls significantly below the storage pressure such that the preferred spray out pressure cannot be generated without re-pressurizing tank 124.

According to certain preferred embodiments, gantry 200 includes a platform 170 configured to transport objects. Objects to be transported may include, but are not limited to, tools, personnel, growing troughs, and mechanical equipment. Platform 170 preferably has a weight-carrying capacity of up to 1500 kilograms. It is preferred that platform 170 extends along the entire length of the gantry which overlies the crop growing area. Preferably, the length of platform 170 is at least 80% of the total length of the gantry. Preferably, a lifter 172 is attached to platform 170 for lifting and lowering the platform. Types of lifters may include, but are not limited to, hydraulic lifts, gear lifts, and scissor lifts, and may be manually operated or electrically actuated by power provided by rechargeable power supply 150. Positioning information about growing troughs is advantageous by virtue of the lifting and transporting of growing troughs.

According to certain preferred embodiments, gantry 200 includes at least one RFID reader 190. It is preferred that an RFID tag is placed in each growing trough in the crop growing area as well as the along the perimeter of the crop growing area along which gantry 200 is configured to operate. In such an embodiment, when gantry 200 passes over an RFID tag, RFID reader 190 transmits an interrogator signal and receives an authentication signal from the RFID tag. The authentication signals received by RFID reader 190 provide an indication as to the position of the growing troughs, as well as the treatment type for the plants in the growing troughs. The treatment type may include, but is not limited to, the liquid droplet size of the mist from spraying nozzles 122, fan 160 operation modes, pesticide solution type, and any combination thereof. This is of particular value when the crop growing area is subdivided into different regions for different plants, where the different plants may require different treatment types. Preferably, RFID reader 190 is associated with a control device, most preferably flow controller 140. Preferably RFID reader 190 is associated with a processor coupled to a data storage medium such as a memory with a database in order to match RFID tags with plant types and treatment types. The processor can be any number of computer processors including, but are not limited to, a microprocessor, an ASIC, a DSP, a state machine, and a microcontroller. Such processors include, or may be in communication with computer readable media, which stores program code or instruction sets that, when executed by the processor, cause the processor to perform actions. Types of computer readable media include, but are not limited to, electronic, optical, magnetic, or other storage or transmission device capable of providing a processor with computer readable instructions. It is preferred that the RFID reader 190 and RFID tags are operable in the low frequency (LF) band which is between 30 kHz and 300 kHz.

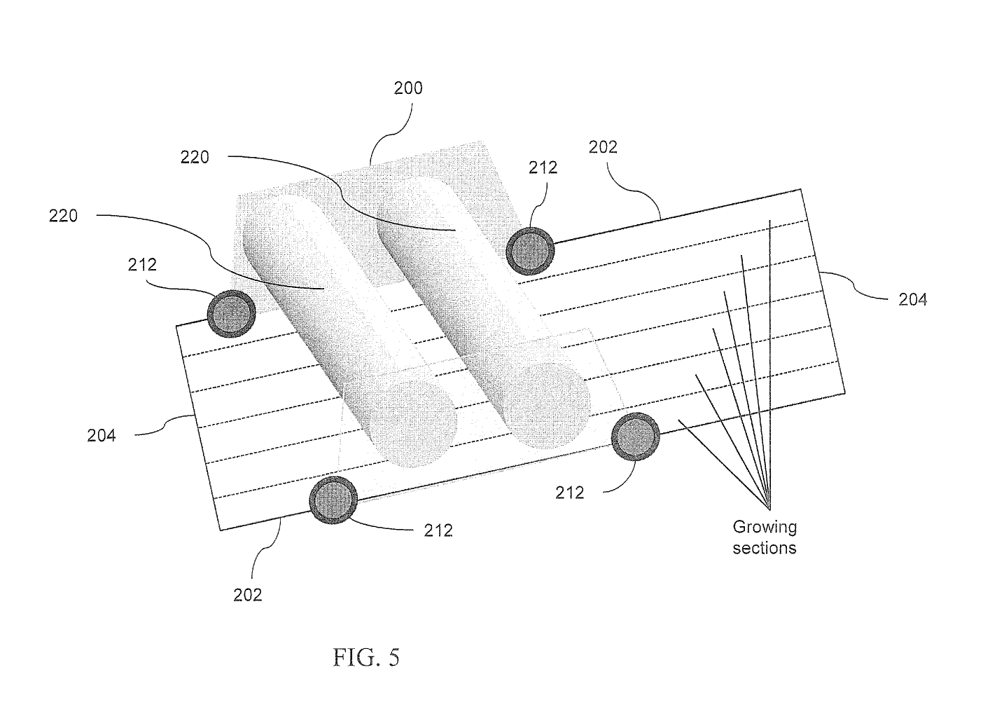

Although the system described thus far has pertained to a spraying system 110 mounted to a gantry 200, where the spraying system 110 includes a pressure vessel 124, other embodiments are possible in which one, or more preferably two, long air pressure tanks 220 are used to provide the pressurized air to spray nozzles 122 as well as to form a structural component of gantry 200. In one preferred implementation of such an embodiment, as depicted in FIG. 5, air pressure tanks 220 are preferably substantially the same length as the total length of gantry 200. Typically, air pressure tanks are manufactured from materials to create strong sidewalls, therefore the strength of the material forming air pressure tanks 220 can be exploited to serve the structural functions of gantry 200. An advantage of using air pressure tanks 220 as a main structural component of gantry 200 is the prolonged amount of time where the spray out pressure is in the preferred range. This will reduce the number of times gantry 200 is required to dock at home position 400 to re-pressurize the air pressure source. Air pressure tanks 220 typically replace tank 124. In all other respects, the structure and function of the system of FIG. 5 is analogous to that of the systems described above, and will be understood by reference to the above description.

Although the system described thus far has pertained to a spraying system 110 mounted to a single gantry 200 with wheels that move along the perimeter of a crop growing area to service an entire length of a growing area, optionally, a plurality of gantries 200 with mounted spraying systems 110 are deployed to move across a crop growing area, either together servicing the entire area with overlapping regions of coverage for use wherever needed, or by subdividing the crop growing area into a plurality of non-overlapping growing subsections with one gantry 200 deployed to move across each growing subsection. Each gantry preferably has its own “home location” for charging and refilling the air pressure tank.

Although the system described thus far has pertained to a spraying system 110 mounted to a gantry 200 with motorized wheel assemblies 210 mounted to gantry 200, other embodiments are possible in which the wheel assemblies do not include a motor. In such an embodiment, a plurality of cables driven by a motor may be connected to gantry 200 in order to push and pull gantry 200 along the suitably shaped profile.

It will be appreciated that all controller devices in the above descriptions may be housed in a single processor or housed individually in a distributed group of processors and/or processing systems. Any or all of the processing may be executed locally on system 10 or in combination may be executed remotely via wired or wireless network or via a cloud based system.

It will be appreciated that the above descriptions are intended only to serve as examples, and that many other embodiments are possible within the scope of the present invention as defined in the appended claims.

What is claimed is:

1. A mobile plant service system for treating plants in a crop growing area comprising:
(a) a transport device deployed for moving across the crop growing area;
(b) a spraying apparatus mounted to said transport device for delivering an atomized liquid to the plants in the crop growing area, comprising:
(i) a plurality of spray nozzles;
(ii) a pressure vessel in fluid flow connection with said plurality of spray nozzles configured for storing compressed air at a storage pressure;
(iii) a pressure regulating valve assembly in fluid flow connection with said pressure vessel;
(iv) a receptacle containing a liquid in fluid flow connection with said spray nozzles;
(c) a flow controller associated with said pressure regulating valve assembly; and
(d) a rechargeable power supply deployed to provide power to said flow controller,
wherein said flow controller is configured to actuate said pressure regulating valve assembly to allow the flow of a controlled release of compressed air to said plurality of spray nozzles at a spray out pressure.

2. The mobile plant service system of claim 1, wherein said transport device is a gantry.

3. The mobile plant service system of claim 2, further comprising a plurality of fans mounted to said gantry;
wherein each of said fans has variable rotary speeds and directions of rotation,
and wherein each of said fans is associated with a fan controller,
and wherein said fan controller is configured to selectively actuate each of said fans to independently operate in a plurality of operational modes,
and wherein each of said operational modes corresponds to at least one rotary speed and direction of rotation.

4. The mobile plant service system of claim 3, wherein each of said fans has variable blade angles, and
wherein each of said operational modes corresponds to at least one rotary speed, direction of rotation, and blade angle.

5. The mobile plant service system of claim 3, further comprising an actuator associated with said fan controller; wherein said actuator is configured to adjust a pointing angle of each of said fans.

6. The mobile plant service system of claim 5, wherein said actuator is further configured to adjust a blade angle of each of said fans.

7. The mobile plant service system of claim 6, wherein said flow controller and said fan controller are implemented as a single processing system having at least one processor.

8. The mobile plant service system of claim 6, wherein said operational modes include:
(i) a pest reduction mode,
wherein any or all of said fans operate to create a suction air flow whereby pests in proximity of a fan are sucked into the blades of said fan;
(ii) a plant stressing mode,
wherein any or all of said fans operate at angles and speeds designed to stress a specified plant; and
(iii) a pollination mode,
wherein any or all of said fans operate at angles and speeds designed for artificial pollination of specified plants.

9. The mobile plant service system of claim 8, further comprising a plurality of nets with a sieve opening size of at most 0.5 millimeters, wherein said nets are attached to said fans;
and wherein said nets are configured to retain pests sucked into said fans when operating in said pest protection mode.

10. The mobile plant service system of claim 2, further comprising a plurality of wheel assemblies mounted to said gantry, wherein each of said wheel assemblies comprises:
(i) at least one wheel;
(ii) a braking arrangement associated with said at least one wheel;
(iii) a drive system associated with said at least one wheel; and
(iv) a wheel controller associated with said braking arrangement and said drive system,
wherein said at least one wheel is configured to operate along a profile disposed about the periphery of the crop growing area,
and wherein said rechargeable power supply is deployed to provide power to said drive system,
and wherein said wheel controller is configured to actuate said drive system to rotate said at least one wheel at an adjustable direction of rotation and to selectively operate said braking arrangement.

11. The mobile plant service system of claim 2, further comprising a home station with a stationary charging arrangement;
wherein said gantry has a home position in said home station,
and wherein said stationary charging arrangement is configured to come into operative cooperation with said rechargeable power supply when said gantry is in said home position.

12. The mobile plant service system of claim 11, wherein said home station further comprises a compressed air filling linkage associated with a mains voltage power supply;
wherein said compressed air filling linkage is deployed for connection with said pressure vessel when said gantry is in said home position,
and wherein said mains voltage power supply is an alternating current (AC) power supply configured to supply a voltage of at least 100 volts AC.

13. The mobile plant service system of claim 2, further comprising a platform mounted to said gantry,
wherein said platform extends along a majority of said gantry.

14. The mobile plant service system of claim 2, further comprising a lifter mounted to said gantry;
wherein said lifter is configured to lift growing troughs containing plants grown by hydroponics and/or aeroponics.

15. The mobile plant service system of claim 2, further comprising at least one RFID reader mounted to said gantry and operable to transmit an interrogator signal and to receive an authentication signal,
such that, wherein said at least one RFID reader passes over an RFID tag in a growing trough and transmits interrogator signals, authentication signals are generated, thereby indicating a position of the growing trough and a treatment type for the plants in the crop growing area.

16. The mobile plant service system of claim 1, wherein said storage pressure is in a range from 5 atm to 12 atm.

17. The mobile plant service system of claim 16, wherein said spray output pressure is in a range from 3 atm to 4 atm.

18. The mobile plant service system of claim 1, wherein said receptacle is a reservoir containing a liquid; and
wherein said reservoir is in fluid flow connection with said pressure vessel,
and wherein said pressure vessel is further configured to pressurize the liquid in said reservoir.

19. The mobile plant service system of claim 1, wherein said rechargeable power supply is a direct current (DC) power supply configured to supply a voltage of no more than 25 volts DC.

20. The mobile plant service system of claim 1, further comprising a pump associated with said rechargeable power supply and in fluid flow connection with said pressure vessel,
wherein said flow controller is further configured to actuate said pump to pressurize said pressure vessel.

21. The mobile plant service system of claim 1, wherein said spraying apparatus is configured to generate spray with a liquid droplet size in a range from 8-50 microns.
